(19) United States
(12) Patent Application Publication
(10) Pub. No.: US 2026/0280217 A1
(43) Pub. Date: Sep. 17, 2026

(54) LASER CHAMBER AND ELECTRONIC DEVICE MANUFACTURING METHOD

(71) Applicant: Gigaphoton Inc., Tochigi (JP)

(72) Inventor: Hitoshi OHGA, Tochigi (JP)

(73) Assignee: Gigaphoton Inc., Tochigi (JP)

(21) Appl. No.: 19/467,869

(22) Filed: Feb. 3, 2026

(30) Foreign Application Priority Data
Mar. 13, 2025 (JP) 2025-040490

(51) Int. Cl. H01S 3/036; H01S 3/0971

(52) U.S. Cl. CPC H01S 3/036; H01S 3/0971

(57) ABSTRACT

A laser chamber includes a housing having an inner wall including a plurality of guide components provided with a gap, the guide component having an inclined surface by which the gap is narrowed toward an opening at an interior side of the housing; a pair of discharge electrodes arranged at the interior; and a fan arranged at the interior and configured to cause a laser gas at the interior to circulate along the inner wall.

### CROSS-REFERENCE TO RELATED APPLICATIONS

The present application claims the benefit of Japanese Patent Application No. 2025-040490, filed on Mar. 13, 2025, the entire contents of which are hereby incorporated by reference.

### BACKGROUND

### 1. Technical Field

The present disclosure relates to a laser chamber and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

Since excimer laser light output from a KrF excimer laser device or an ArF excimer laser device has a pulse width of several tens of ns and a wavelength thereof is short as about 248 nm or 193 nm, excimer laser light is sometimes used for direct processing of a polymer material, a glass material, or the like. Chemical bonds in polymeric materials can be broken by excimer laser light having a photon energy higher than the bond energy. Therefore, it is known that non-heating processing of polymeric materials is possible with excimer laser light, and that the processing shape is beautiful. Further, it is known that, since glass, ceramics, and the like have high absorptance with respect to excimer laser light, even a material that is difficult to be processed with visible and infrared laser light can be processed with excimer laser light.

### LIST OF DOCUMENTS

### Patent Documents

Patent Document 1: Japanese Patent Application Publication No. 2007-208183

Patent Document 2: US Patent Application Publication No. 2003/031225

### SUMMARY

A laser chamber according to an aspect of the present disclosure includes a housing having an inner wall including a plurality of guide components provided with a gap, the guide component having an inclined surface by which the gap is narrowed toward an opening at an interior side of the housing; a pair of discharge electrodes arranged at the interior; and a fan arranged at the interior and configured to cause a laser gas at the interior to circulate along the inner wall.

An electronic device manufacturing method according to an aspect of the present disclosure includes generating laser light using a laser device, outputting the laser light to an exposure apparatus, and exposing a photosensitive substrate to the laser light in the exposure apparatus to manufacture an electronic device. Here, the laser device includes an optical resonator, and a laser chamber arranged on an optical path of the optical resonator. The laser chamber includes a housing having an inner wall including a plurality of guide components provided with a gap, the guide component having an inclined surface by which the gap is narrowed toward an opening at an interior side of the housing; a pair of discharge electrodes arranged at the interior; and a fan arranged at the interior and configured to cause a laser gas at the interior to circulate along the inner wall.

### BRIEF DESCRIPTION OF THE DRAWINGS

Embodiments of the present disclosure will be described below merely as examples with reference to the accompanying drawings.

FIG. 1 shows the configuration of a laser device of a comparative example.

FIG. 2 shows the configuration of a laser chamber of the comparative example viewed in a −Z direction.

FIG. 3 shows a part of a housing of the comparative example.

FIG. 4 shows a part of the housing of a first embodiment.

FIG. 5 shows an example of a gap of the first embodiment.

FIG. 6 shows another example of the gap of the first embodiment.

FIG. 7 shows an example of the gap located at a boundary between an upper case and a lower case of a second embodiment.

FIG. 8 shows a part of the housing of a third embodiment.

FIG. 9 is a view of a part of the housing shown in FIG. 8 viewed in a V direction.

FIG. 10 shows an example of the gap of a fourth embodiment.

FIG. 11 shows another example of the gap of the fourth embodiment.

FIG. 12 shows the configuration of an exposure system.

### DESCRIPTION OF EMBODIMENTS

### Contents

1. Comparative example
   1.1 Configuration
   1.2 Operation
2. Problem of comparative example
3. Laser chamber 10 in which guide component includes inclined surface 191
   3.1 Configuration
   3.2 Effect
4. Laser chamber 10 in which gap G at boundary between upper case 19g and lower case 19h is formed by inclined surface 191
   4.1 Configuration
   4.2 Effect
5. Laser chamber 10 including facing surface 193 inclined about axis in V direction
   5.1 Configuration
   5.2 Effect
6. Laser chamber 10 having sound absorbing material 18 arranged in gap G
   6.1 Configuration
   6.2 Effect
7. Others
   7.1 Electronic device manufacturing method
   7.2 Laser control processor 30
   7.3 Supplement

Hereinafter, embodiments of the present disclosure will be described in detail with reference to the drawings. The embodiments described below shows some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Comparative Example

### 1.1 Configuration

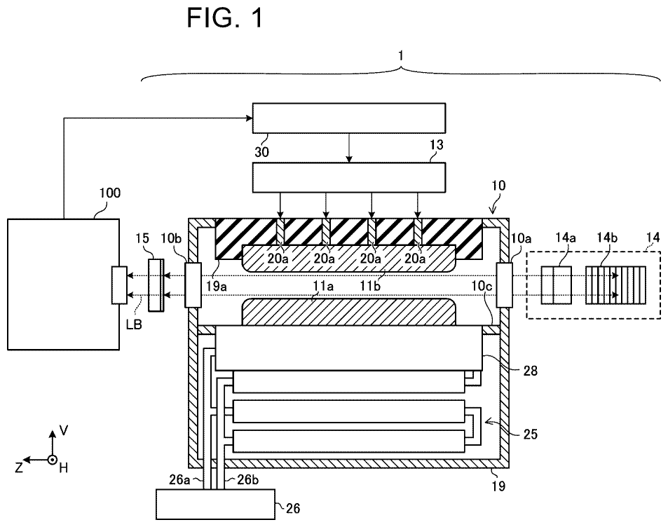

FIG. 1 shows the configuration of a laser device 1 of a comparative example. The comparative example of the present disclosure is an example recognized by the applicant as known only by the applicant, and is not a publicly known example admitted by the applicant.

The laser device 1 is a discharge-excitation-type gas laser device capable of outputting laser light LB to an exposure apparatus 100. The laser device 1 includes a laser chamber 10, a power source device 13, a line narrowing module 14, an output coupling mirror 15, a heat exchanger 26, and a laser control processor 30. The line narrowing module 14 and the output coupling mirror 15 configure an optical resonator. The laser chamber 10 includes windows 10a, 10b, a pair of discharge electrodes 11a, 11b, and a housing 19. The laser chamber 10 is arranged such that the windows 10a, 10b are located on the optical path of the optical resonator. The laser control processor 30 will be described later.

The line narrowing module 14 includes a prism 14a and a grating 14b. The prism 14a is arranged on the optical path of light output from the window 10a. The grating 14b is arranged on the optical path of the light having transmitted through the prism 14a. The output coupling mirror 15 is configured by a partial reflection mirror.

The travel direction of the laser light LB output from the output coupling mirror 15 is represented by a Z direction. Each of the discharge electrodes 11a, 11b extends in the Z direction. The direction in which the discharge electrodes 11a, 11b face each other is represented as a V direction or a −V direction. The Z direction and the V direction are perpendicular to each other, and the direction perpendicular to both of them is represented by a H direction or a −H direction. In FIG. 1, the configuration of the laser device 1 is shown as viewed in the −H direction.

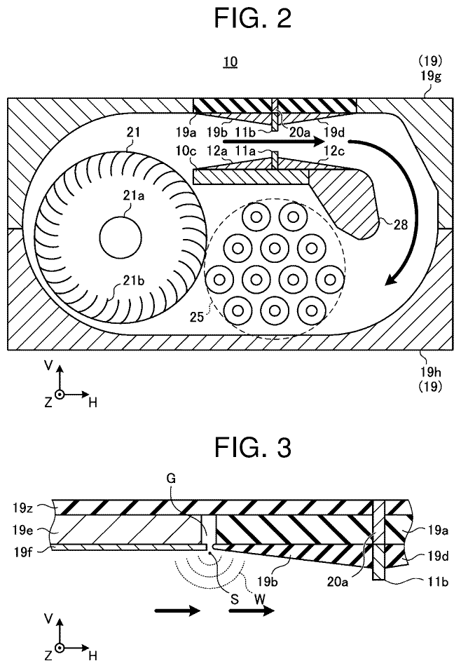

FIG. 2 shows the configuration of the laser chamber 10 of the comparative example viewed in a −Z direction. The housing 19 included in the laser chamber 10 accommodates the discharge electrodes 11a, 11b, inclined members 12a to 12c, a cross flow fan 21, a cooling unit 25, and a guide portion 28. The cross flow fan 21 corresponds to the fan in the present disclosure.

The housing 19 is filled with a laser gas containing, for example, an argon gas or a krypton gas as a rare gas, a fluorine gas as a halogen gas, a neon gas as a buffer gas, and the like. Alternatively, a laser gas containing a fluorine gas and a buffer gas may be enclosed.

The housing 19 includes an upper case 19g that accommodates the discharge electrodes 11a, 11b, and a lower case 19h that accommodates a part of the cross flow fan 21. A part of the upper case 19g is configured by an electrically insulating portion 19a. The electrically insulating portion 19a supports the discharge electrode 11b. A plurality of conductive portions 20a are embedded in the electrically insulating portion 19a. Each of the conductive portions 20a is electrically connected to the discharge electrode 11b. The power source device 13 (see FIG. 1) includes a charger (not shown) and is connected to the discharge electrode 11b via the conductive portions 20a. Each of the inclined members 19b, 19d configuring a part of the upper case 19g has a triangular prism shape, and is fixed to the electrically insulating portion 19a so as to cover a part of a corresponding side surface of the discharge electrode 11b.

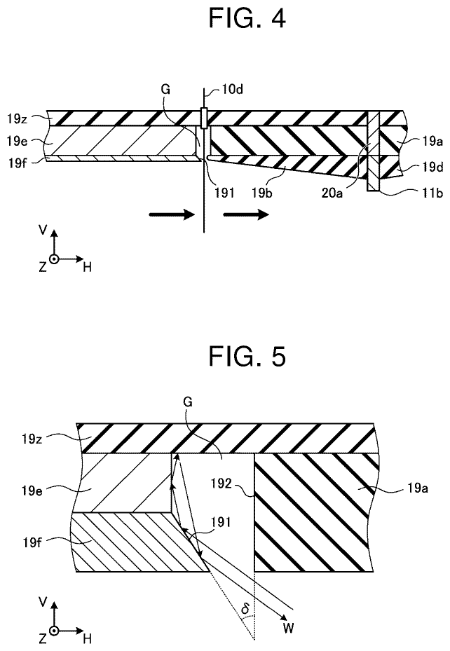

A return plate 10c is arranged in the laser chamber 10. The discharge electrode 11a is supported by the return plate 10c. The discharge electrode 11a is electrically connected to the ground potential via the return plate 10c and a conductive wiring 10d (see FIG. 4) described later. As shown in FIG. 2, the return plate 10c defines a gap through which the laser gas passes on each of the front and back sides of the paper surface of FIG. 1. Each of the inclined members 12a, 12c has a triangular prism shape and is fixed to the return plate 10c so as to cover a part of a corresponding side surface of the discharge electrode 11a.

The cross flow fan 21 includes a plurality of blades 21b arranged around a rotary shaft 21a. The rotary shaft 21a is connected to a motor (not shown).

The inclined members 12a, 19b are arranged to gradually narrow the flow path of the laser gas so as to efficiently guide the laser gas fed from the cross flow fan 21 to a discharge space between the discharge electrodes 11a, 11b. The inclined members 12c, 19d are arranged to gradually expand the flow path of the laser gas so as to efficiently guide the laser gas having passed through the discharge space in a direction of approaching the guide portion 28.

The guide portion 28 is fixed to the inclined member 12c so as to guide the laser gas having passed between the inclined members 12c, 19d to the cooling unit 25.

The cooling unit 25 includes a plurality of refrigerant pipes and heat radiation fins arranged around each of the refrigerant pipes. Each of the refrigerant pipes is arranged such that the longitudinal direction thereof extends in the Z direction. The refrigerant pipes are connected to the heat exchanger 26 via pipes 26a, 26b (see FIG. 1).

### 1.2 Operation

The laser control processor 30 receives a target value of a pulse energy E and a light emission trigger signal from the exposure apparatus 100. The laser control processor 30 transmits setting data of a charge voltage to the charger included in the power source device 13 based on the target value of the pulse energy E. Further, the laser control processor 30 transmits a trigger signal to the power source device 13 based on the light emission trigger signal.

Upon receiving the trigger signal from the laser control processor 30, the power source device 13 generates a pulse high voltage from the electric energy charged to the charger and applies the high voltage between the discharge electrodes 11a, 11b.

When the high voltage is applied between the discharge electrodes 11a, 11b, discharge occurs between the discharge electrodes 11a, 11b. The laser medium in the laser chamber 10 is excited by the energy of the discharge and shifts to a high energy level. When the excited laser medium then shifts to a low energy level, light having a wavelength corresponding to the difference between the energy levels is emitted.

The light generated in the laser chamber 10 is output to the outside of the laser chamber 10 through the windows 10a, 10b. The beam width of the light output through the window 10a of the laser chamber 10 is expanded in the plane parallel to an HZ plane by the prism 14a, and then the light is incident on the grating 14b.

The light incident on the grating 14b is reflected by a plurality of grooves of the grating 14b and is diffracted in a direction corresponding to the wavelength of the light. By matching the incident angle of the light incident on the grating 14b with the diffraction angle of the diffracted light having a desired wavelength, the wavelength of the diffracted light returning to the prism 14a from the grating 14b is selected. The prism 14a reduces the beam width, in the plane parallel to the HZ plane, of the diffracted light returning from the grating 14b and returns the light to the laser chamber 10 through the window 10a.

The output coupling mirror 15 transmits and outputs a part of the light output through the window 10b of the laser chamber 10, and reflects the other part back into the laser chamber 10.

In this way, the light output from the laser chamber 10 reciprocates between the line narrowing module 14 and the output coupling mirror 15. The light is amplified every time it passes through the discharge space between the discharge electrodes 11a, 11b, and is line-narrowed every time the light is turned back by the line narrowing module 14. Thus, the light having undergone laser oscillation and line narrowing is output as the laser light LB from the output coupling mirror 15, and enters the exposure apparatus 100.

When the motor (not shown) rotates the cross flow fan 21, the laser gas flows and circulates through the inside of the laser chamber 10 along the inner surface of the housing 19 as indicated by arrows in FIG. 2. Discharge products generated from the laser gas excited by the discharge between the discharge electrodes 11a, 11b are removed from the discharge space by the flow of the laser gas by the time of the subsequent discharge. Accordingly, the discharge space and the vicinity thereof are in a state in which there is little discharge products, so that the discharge can be stabilized. The repeated discharge generates a dense wave of the laser gas, and the dense wave propagates through the interior of the housing 19 as an acoustic wave.

### 2. Problem of Comparative Example

FIG. 3 shows a part of the housing 19 of the comparative example. The housing 19 includes conductive portions 19e, 19f and an outer wall 19z in addition to the electrically insulating portion 19a and the inclined members 19b, 19d. The inclined members 19b, 19d and the conductive portions 19e, 19f configure the inner wall of the present disclosure, and each of them is an example of the guide component of the present disclosure. The inclined member 19b corresponds to the insulating guide component in the present disclosure, and the conductive portion 19f corresponds to the conductive guide component in the present disclosure.

A gap G is formed between the electrically insulating portion 19a and the conductive portion 19e due to considerations such as processing accuracy thereof and necessity of passing the conductive wiring 10d connected to the return plate 10c. The conductive portion 19f is arranged so as to cover the surface of the conductive portion 19e on an interior side of the laser chamber 10. The gap G extends to between the conductive portion 19f and the inclined member 19b. The outer wall 19z is arranged to cover and seal the gap G from an outer side of the laser chamber 10.

The conductive portion 19f and the inclined member 19b guide the laser gas in the H direction toward the discharge space between the discharge electrodes 11a, 11b.

A part of the acoustic wave propagating from the discharge space between the discharge electrodes 11a, 11b is reflected in the gap G, and propagates radially through the interior of the housing 19 as a return acoustic wave W having the position near the gap G as a line sound source S. The reason why the sound source of the return acoustic wave W becomes the line sound source S is that the gap G extends in the Z direction and can be regarded as a uniform sound source in the Z direction. The return acoustic wave W may also include an acoustic wave that is a part of the acoustic wave propagating from the discharge space, enters the gap G, is irregularly reflected by the wall surface including the outer wall 19z, and propagates radially through the line sound source S.

When the return acoustic wave W reaches the discharge space, density of the laser gas becomes uneven in the discharge space and the refractive index of the light becomes uneven, so that the light intensity distribution of the laser light LB may vary and the beam quality may deteriorate. Here, the return acoustic wave W having the gap between the conductive portion 19f and the inclined member 19b as the line sound source S has been described. When structural elements included in the housing 19 have another gap, the return acoustic wave W from such a gap may cause a similar problem as well. Embodiments described below relate to suppressing generation of the return acoustic wave W to reach the discharge space.

### 3. Laser Chamber 10 in which Guide Component Includes Inclined Surface 191

### 3.1 Configuration

FIG. 4 shows a part of the housing 19 of a first embodiment. In the first embodiment, the conductive portion 19f, which is the innermost layer on the interior side of the laser chamber 10 among the conductive portions 19e, 19f configuring the inner wall of the housing 19, includes an inclined surface 191 so that the gap G narrows toward the opening at the interior side of the housing 19. The direction of the normal line of the inclined surface 191 is inclined about an axis in the Z direction with respect to the H direction, which is the flow direction of the laser gas along the inner wall of the housing 19.

FIG. 5 shows an example of the gap G of the first embodiment. Here, the inclined member 19b is omitted. The electrically insulating portion 19a has a facing surface 192 that faces the inclined surface 191 and forms the gap G with the inclined surface 191. The normal line of the facing surface 192 is substantially parallel to the flow direction of the laser gas along the inner wall of the housing 19. Therefore, the inclination of the normal line of the facing surface 192 with respect to the flow direction of the laser gas is smaller than the inclination of the normal line of the inclined surface 191 with respect to the flow direction of the laser gas.

An angle δ between the facing surface 192 and the inclined surface 191 as viewed from the gap G preferably has a value other than 180°/N, where N is a natural number. For example, in a case where the angle δ is 30°, when the acoustic wave having entered the gap G is reflected twice by the inclined surface 191, the acoustic wave may be output from the gap G as the return acoustic wave W in the direction opposite to the entering direction. Such phenomenon may be avoided by setting the angle δ to a value different from 180°/N. The angle δ is preferably more than 0° and less than 45°, and more preferably more than 36° and less than 45°.

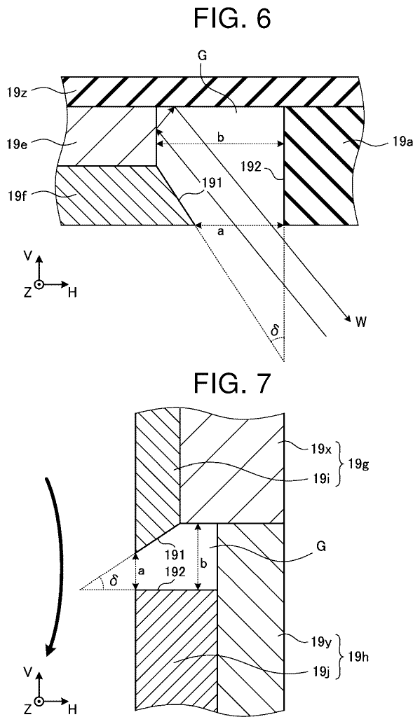

FIG. 6 shows another example of the gap G of the first embodiment. Here, the inclined member 19b is omitted. When the opening width of the opening of the gap G is a, and the inner width of the gap G at the inner portion being opposite to the opening is b, the opening width a is preferably more than 0 and less than (b−a)/sinδ. Here, (b−a)/sinδ corresponds to the length of the inclined surface 191 in a direction perpendicular to the Z direction. When the opening width a is equal to or more than (b−a)/sinδ, there is a high possibility that the acoustic wave having entered the gap G is output from the gap G as the return acoustic wave W in the direction opposite to the entering direction without being incident on the inclined surface 191. Such a possibility can be reduced by setting the opening width a to a value less than (b−a)/sinδ.

In the first embodiment, the conductive wiring 10d (see FIG. 4) electrically connected to the discharge electrode 11a via the return plate 10c may be arranged so as to pass through the gap G, and electrically connected to the ground potential outside the laser chamber 10.

In the first embodiment, the inclined surface 191 is formed on the conductive portion 19f to reduce the processing cost. However, the present disclosure is not limited thereto. The inclined surface 191 may be formed on the inclined member 19b, and the facing surface 192 may be formed on the conductive portion 19e and/or 19f. By forming the inclined surface 191 on the surface closer to the discharge electrodes 11a, 11b among the two opposite surfaces of the guide components forming the gap G, the return acoustic wave W toward the discharge space can be further reduced.

### 3.2 Effect

(1) According to the first embodiment, the laser chamber 10 includes the housing 19, the pair of discharge electrodes 11a, 11b, and the cross flow fan 21. The housing 19 has the inner wall including the conductive portion 19f and the electrically insulating portion 19a serving as the plurality of guide components which form the gap G, and the guide component has the inclined surface 191 by which the gap G is narrowed toward the opening at the interior side of the housing 19. The discharge electrodes 11a, 11b are arranged in the housing 19. The cross flow fan 21 is arranged in the housing 19, and circulates the laser gas in the housing 19 along the inner wall.

Accordingly, since the inner wall of the housing 19 has the inclined surface 191, the acoustic wave is confined in the gap G and attenuated inside the gap G, whereby the return acoustic wave W can be suppressed.

(2) According to the first embodiment, the inner wall of the housing 19 includes a plurality of layers, and the conductive portion 19f, which is the innermost layer on the interior side among the layers, has the inclined surface 191.

Accordingly, since the innermost layer has the inclined surface 191, the acoustic wave can be confined in the space of the gap G.

(3) According to the first embodiment, the gap G extends in the Z direction, which is the longitudinal direction of the discharge electrodes 11a, 11b.

Accordingly, since the Z direction in which the gap G extends coincides with the Z direction in which the discharge space extends, when the return acoustic wave W from the gap G reaches the discharge space, there is a profound influence on the beam quality of the laser light LB. By forming the inclined surface 191 along the gap G to suppress the return acoustic wave W, the influence on the beam quality can be suppressed.

(4) According to the first embodiment, the inclined surface 191 is inclined about an axis parallel to the Z direction in which the gap G extends.

Accordingly, since the inclined surface 191 of the gap G extending in the Z direction is inclined about the axis parallel to the Z direction, the acoustic wave can be confined by being guided toward the inner portion of the gap G.

(5) According to the first embodiment, the electrically insulating portion 19a, which is the guide component, has the facing surface 192 that faces the inclined surface 191 and forms the gap G therebetween, and the inclination of the normal line of the facing surface 192 with respect to the H direction, which is the flow direction of the laser gas along the inner wall of the housing 19, is less than the inclination of the normal line of the inclined surface 191 with respect to the flow direction.

Accordingly, processing can be facilitated by bringing the direction of the normal line of the facing surface 192 close to the H direction.

(6) According to the first embodiment, the angle δ of the inclined surface 191 with respect to the facing surface 192 has a value other than 180°/N, where N is a natural number.

Accordingly, it is possible to suppress the acoustic wave incident on the inclined surface 191 from becoming the return acoustic wave W output in the direction directly opposite to the incident direction.

(7) According to the first embodiment, the angle δ of the inclined surface 191 with respect to the facing surface 192 is more than 0° and less than 45°.

Accordingly, the acoustic wave having entered the gap G from the opening thereof can be guided toward the inner portion from the opening and attenuated.

(8) According to the first embodiment, the angle δ of the inclined surface 191 with respect to the facing surface 192 is more than 36° and less than 45°.

Accordingly, the angle δ of the inclined surface 191 with respect to the facing surface 192 can be easily set to a value other than 180°/N.

(9) According to the first embodiment, the opening width a of the opening of the gap G is more than 0 and less than the value of (b−a)/sinδ obtained by dividing the value b−a, which is obtained by subtracting the opening width a from the inner width b of the gap G at the inner portion thereof being opposite to the opening of the gap G, by the sine of the angle δ of the inclined surface 191 with respect to the facing surface 192.

Accordingly, by setting the opening width a less than (b−a)/sinδ which is the width of the inclined surface 191, there is a high possibility that the acoustic wave is confined in the gap G by being hit to the inclined surface 191 even when it enters the gap G from the opening thereof.

(10) According to the first embodiment, the conductive wiring 10d connected to the outside of the housing 19 and one of the discharge electrodes 11a, 11b is arranged in the gap G.

Accordingly, even though the conductive wiring 10d is arranged in the gap G, the return acoustic wave W can be suppressed due to presence of the inclined surface 191 in the gap G.

(11) According to the first embodiment, the inner wall of the housing 19 includes the conductive portion 19f and the inclined member 19b, and the gap G is located between the conductive portion 19f and the inclined member 19b.

Accordingly, although the gap G is likely to be formed between the conductive portion 19f and the inclined member 19b due to the processing accuracy, the return acoustic wave W can be suppressed due to the presence of the inclined surface 191.

(12) In the first embodiment, the inclined member 19b may have an inclined surface.

Accordingly, the return acoustic wave W toward the discharge space between the discharge electrodes 11a, 11b can be further reduced than when the conductive portion 19f has the inclined surface 191.

(13) In the first embodiment, the inclined surface may be a surface closer to the discharge electrodes 11a, 11b among two opposite surfaces of the conductive portion 19f and the inclined member 19b, which are guide components, the two opposite surfaces forming the gap G.

Accordingly, by forming the surface closer to the discharge electrodes 11a, 11b as the inclined surface, the return acoustic wave W toward the discharge space between the discharge electrodes 11a, 11b can be further reduced.

In other respects, the first embodiment is similar to the comparative example.

### 4. Laser Chamber 10 in which Gap G at Boundary between Upper Case 19g and Lower Case 19h is Formed by Inclined Surface 191

### 4.1 Configuration

FIG. 7 shows an example of the gap G located at a boundary between an upper case 19g and a lower case 19h in a second embodiment. The upper case 19g includes a first guide component 19i and an outer wall 19x, and the lower case 19h includes a second guide component 19j and an outer wall 19y. The first guide component 19i and the second guide component 19j configure the inner wall of the present disclosure, each of which is an example of the guide component of the present disclosure. The gap G is located between the first guide component 19i and the second guide component 19j, and the inclined surface 191 of the first guide component 19i is formed so that the gap G is narrowed toward the opening at the interior side of the housing 19. The direction of the normal line of the inclined surface 191 is inclined about the axis in the Z direction with respect to the −V direction, which is the flow direction of the laser gas along the inner wall of the housing 19. The second guide component 19j is formed with the facing surface 192 facing the inclined surface 191.

In the second embodiment, the return acoustic wave W toward the discharge space can be reduced by forming the inclined surface 191 on the first guide component 19i, but the present disclosure is not limited thereto. The inclined surface 191 may be formed on the second guide component 19j, and the facing surface 192 may be formed on the first guide component 19i.

### 4.2 Effect

(14) According to the second embodiment, the inner wall of the housing 19 includes the first guide component 19i accommodating the discharge electrodes 11a, 11b, and the second guide component 19j accommodating a part of the cross flow fan 21, and the gap G is located between the first guide component 19i and the second guide component 19j.

Accordingly, although the gap G is likely to be formed between the first guide component 19i and the second guide component 19j, the return acoustic wave W can be suppressed due to the presence of the inclined surface 191.

In other respects, the second embodiment is similar to the first embodiment.

### 5. Laser Chamber 10 Including Facing Surface 193 Inclined About Axis in V Direction

### 5.1 Configuration

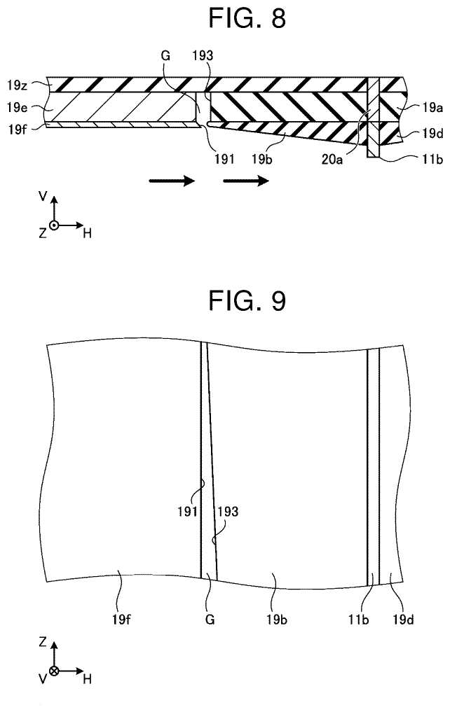

FIG. 8 shows a part of the housing 19 of a third embodiment. FIG. 9 is a view of a part of the housing 19 shown in FIG. 8 viewed in the V direction. In the third embodiment, the facing surface 193 facing the inclined surface 191 is inclined about the axis in the V direction perpendicular to both the flow direction of the laser gas and the longitudinal direction of the discharge electrodes 11a, 11b. The inclination angle thereof is preferably more than 0° and less than 5°.

In the third embodiment, description has been provided on a case in which the facing surface 193 is inclined about the axis in the V direction, but the present disclosure is not limited thereto. The inclined surface 191 may be inclined not only about the axis in the Z direction but also about the axis in the V direction. In this case, the facing surface 193 may not be inclined.

Although FIG. 9 shows a case in which the gap G is narrowed toward the positive direction of the Z axis, the present disclosure is not limited thereto. The gap G may be narrowed from a first position and a second position at both ends of the gap G in the Z direction, which is the longitudinal direction of the discharge electrodes 11a, 11b, toward a third position between the first position and the second position.

### 5.2 Effect

(15) According to the third embodiment, one of the two opposite surfaces, for example, the facing surface 193, of the conductive portion 19f and the electrically insulating portion 19a, which are the guide components, forming the gap G is inclined about the axis in the V direction perpendicular to both the flow direction of the laser gas along the inner wall of the housing 19 and the longitudinal direction of the discharge electrodes 11a, 11b.

Accordingly, not only the inclination that narrows the gap G toward the opening thereof but also the inclination about the axis in the V direction is provided, so that the return acoustic wave W can be suppressed as guiding the acoustic wave incident on the gap G also in the direction in which the gap G extends.

(16) According to the third embodiment, the inclination angle of the one surface about the axis in the V direction is more than 0° and less than 5°.

Accordingly, even though the one surface is inclined about the axis in the V direction, it is possible to suppress the gap G from becoming large.

(17) According to the third embodiment, the one surface is the facing surface 193 facing the inclined surface 191.

Accordingly, the angle δ of the inclined surface 191 having the inclination being narrowed toward the opening and the inclination angle of the facing surface 193 having the inclination about the axis in the V direction can be separately set.

(18) In the third embodiment, the facing surface 193 may be inclined about the axis in the V direction so that the gap G is narrowed from the first and second positions at both ends in the Z direction in which the gap G extends toward the third position between the first and second positions.

Accordingly, since the facing surface 193 is inclined so that the gap G is narrowed from both ends in the Z direction toward the third position therebetween, the return acoustic wave W can be suppressed as guiding the acoustic wave away from the center of the discharge space.

In other respects, the third embodiment is similar to the first embodiment. Alternatively, in the second embodiment, one of the two surfaces forming the gap G may be inclined about the axis in the V direction perpendicular to both the flow direction of the laser gas and the longitudinal direction of the discharge electrodes 11a, 11b.

### 6. Laser Chamber 10 Having Sound Absorbing Material 18 Arranged in Gap G

### 6.1 Configuration

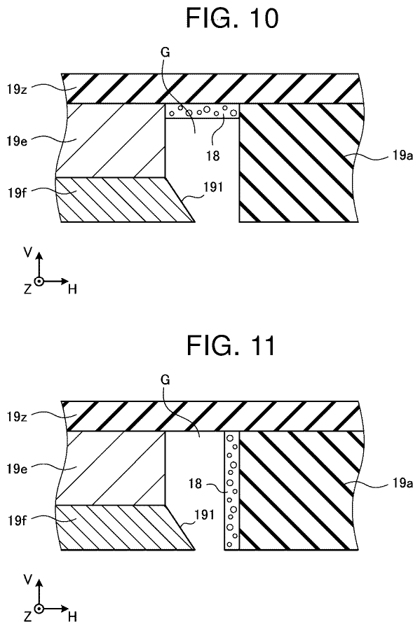

FIG. 10 shows an example of the gap G of a fourth embodiment. In the fourth embodiment, a sound absorbing material 18 is arranged in the gap G. The sound absorbing material 18 may be arranged, for example, in a part of the gap G in contact with the outer wall 19z.

The material of the sound absorbing material 18 may be foamed nickel-based material or porous alumina. Any of the above is difficult to react with the fluorine gas, and thus is difficult to deteriorate. Foamed nickel-based material is superior in sound absorbability and processability. However, since porous alumina is an insulator, a short circuit can be suppressed even when the discharge electrode 11b is close to the porous alumina.

FIG. 11 shows another example of the gap G of the fourth embodiment. The sound absorbing material 18 may be arranged, for example, in a part of the gap G in contact with the electrically insulating portion 19a.

### 6.2 Effect

(19) According to the fourth embodiment, the sound absorbing material 18 is arranged in the gap G.

Accordingly, reflection of the acoustic wave can be suppressed by arranging the sound absorbing material 18, and the acoustic wave can be attenuated in the gap G.

In other respects, the fourth embodiment is similar to the first embodiment. Alternatively, in the second embodiment or in the third embodiment, the sound absorbing material 18 may be arranged in the gap G.

### 7. Others

### 7.1 Electronic Device Manufacturing Method

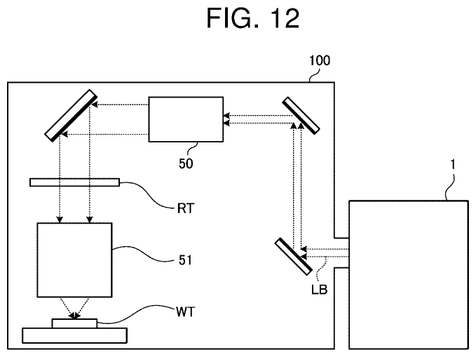

FIG. 12 shows the configuration of an exposure system. The exposure system includes the laser device 1 and the exposure apparatus 100. The laser device 1 is configured to output the laser light LB toward the exposure apparatus 100.

The exposure apparatus 100 includes an illumination optical system 50 and a projection optical system 51. The illumination optical system 50 illuminates a reticle pattern of a reticle (not shown) arranged on a reticle stage RT with the laser light LB incident from the laser device 1. The projection optical system 51 causes the laser light LB transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 100 synchronously translates the reticle stage RT and the workpiece table WT to expose the workpiece to the laser light LB reflecting the reticle pattern. After the reticle pattern is transferred onto the semiconductor wafer by the exposure process described above, an electronic device can be manufactured through a plurality of processes.

### 7.2 Laser Control Processor 30

The laser control processor 30 may be physically configured as hardware to execute various processes included in the present disclosure. For example, the laser control processor 30 may be a computer including a memory that stores a control program defining the various processes and a processing device that executes the control program. The control program may be stored in one memory, or may be stored separately in a plurality of memories at physically separate locations, and the various processes included may be defined by the control program as an aggregation thereof. The processing device may be a general-purpose processing device such as a CPU or a special-purpose processing device such as a GPU.

Alternatively, the laser control processor 30 may be programmed as software to execute the various processes included in the present disclosure. For example, the laser control processor 30 may be implemented in a dedicated device such as an ASIC or a programmable device such as an FPGA.

The various processes included in the present disclosure may be executed by one computer, one dedicated device, or one programmable device, or may be executed by cooperation of a plurality of computers, a plurality of dedicated devices, or a plurality of programmable devices at physically separate locations. The various processes may be executed by a combination including at least any two of: one or more computers, one or more dedicated devices, and one or more programmable devices.

### 7.3 Supplement

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser chamber comprising:
a housing having an inner wall including a plurality of guide components provided with a gap, the guide component having an inclined surface by which the gap is narrowed toward an opening at an interior side of the housing;
a pair of discharge electrodes arranged at the interior; and
a fan arranged at the interior and configured to cause a laser gas at the interior to circulate along the inner wall.

2. The laser chamber according to claim 1,
wherein the inner wall includes a plurality of layers, and an innermost layer on the interior side among the layers has the inclined surface.

3. The laser chamber according to claim 1,
wherein the gap extends in a longitudinal direction of the discharge electrodes.

4. The laser chamber according to claim 3,
wherein the inclined surface is inclined about an axis parallel to a direction in which the gap extends.

5. The laser chamber according to claim 1,
wherein the guide component has a facing surface that faces the inclined surface and forms the gap with the inclined surface, and
inclination of a normal line of the facing surface with respect to a flow direction of the laser gas along the inner wall is smaller than inclination of a normal line of the inclined surface with respect to the flow direction.

6. The laser chamber according to claim 1,
wherein the guide component has a facing surface that faces the inclined surface and forms the gap with the inclined surface, and
an angle of the inclined surface with respect to the facing surface has a value other than 180°/N where N is a natural number.

7. The laser chamber according to claim 1,
wherein the guide component has a facing surface that faces the inclined surface and forms the gap with the inclined surface, and
an angle of the inclined surface with respect to the facing surface is more than 0° and less than 45°.

8. The laser chamber according to claim 1,
wherein the guide component has a facing surface that faces the inclined surface and forms the gap with the inclined surface, and
an angle of the inclined surface with respect to the facing surface is more than 36° and less than 45°.

9. The laser chamber according to claim 1,
wherein the guide component has a facing surface that faces the inclined surface and forms the gap with the inclined surface, and
an opening width a of the opening of the gap is more than 0, and is less than a value of (b−a)/sinδ obtained by dividing a value b−a, which is obtained by subtracting the opening width a from an inner width b of the gap at an inner portion of the gap being opposite to the opening, by a sine of an angle δ of the inclined surface with respect to the facing surface.

10. The laser chamber according to claim 1,
wherein a conductive wiring connected to an outside of the housing and one of the discharge electrodes is arranged in the gap.

11. The laser chamber according to claim 1,
wherein the inner wall includes a conductive guide component and an insulating guide component, and
the gap is located between the conductive guide component and the insulating guide component.

12. The laser chamber according to claim 11,
wherein the insulating guide component has the inclined surface.

13. The laser chamber according to claim 1,
wherein the inclined surface is a surface close to the discharge electrodes among two opposite surfaces of the guide components, the two opposite surfaces forming the gap.

14. The laser chamber according to claim 1,
wherein the inner wall includes a first guide component accommodating the discharge electrodes and a second guide component accommodating a part of the fan, and
the gap is located between the first guide component and the second guide component.

15. The laser chamber according to claim 1,
wherein one of two opposite surfaces, of the guide components, forming the gap is inclined about an axis perpendicular to both a flow direction of the laser gas along the inner wall and a longitudinal direction of the discharge electrodes.

16. The laser chamber according to claim 15,
wherein an inclination angle of the one surface about the axis is more than 0° and less than 5°.

17. The laser chamber according to claim 15,
wherein the one surface is a surface facing the inclined surface.

18. The laser chamber according to claim 15,
wherein the gap is inclined about the axis so as to narrow from first and second positions at both ends in an extending direction of the gap toward a third position between the first and second positions.

19. The laser chamber according to claim 1,
wherein a sound absorbing material is arranged in the gap.

20. An electronic device manufacturing method, comprising:
generating laser light using a laser device;
outputting the laser light to an exposure apparatus; and
exposing a photosensitive substrate to the laser light in the exposure apparatus to manufacture an electronic device,
the laser device including an optical resonator, and a laser chamber arranged on an optical path of the optical resonator, and
the laser chamber including:
a housing having an inner wall including a plurality of guide components provided with a gap, the guide component having an inclined surface by which the gap is narrowed toward an opening at an interior side of the housing;
a pair of discharge electrodes arranged at the interior; and
a fan arranged at the interior and configured to cause a laser gas at the interior to circulate along the inner wall.
